(19) United States
(12) Patent Application Publication
(10) Pub. No.: US 2017/0203585 A1
(43) Pub. Date: Jul. 20, 2017

(54) PRINTER APPARATUS

(71) Applicant: TOSHIBA TEC KABUSHIKI KAISHA, Tokyo (JP)

(72) Inventor: Tsuyoshi SANADA, Susuno Shizuoka (JP)

(21) Appl. No.: 15/410,367

(22) Filed: Jan. 19, 2017

(30) Foreign Application Priority Data
Jan. 20, 2016 (JP) 2016-008980

(51) Int. Cl. B41J 11/70

(52) U.S. Cl. CPC B41J 11/70

(57) ABSTRACT

A printer apparatus includes an issue opening, a printing section along a transport path of a printable medium, a cutting section disposed downstream of the printing section along the transport path of the printable medium, and a temporary fastening section disposed downstream of the cutting section along the transport path of the printable medium. The temporary fastening section is configured to hold a leading edge portion of the printing medium at a position laterally offset from the transport path at a time the printable medium is cut by the cutting section after printing by the printing section.

### CROSS-REFERENCE TO RELATED APPLICATION

This application is based upon and claims the benefit of priority from Japanese Patent Application No. 2016-008980, filed Jan. 20, 2016, the entire contents of which are incorporated herein by reference.

### FIELD

Embodiments described herein relate generally to a printer apparatus.

### BACKGROUND

In the related art, a point of system (POS) terminal device has a printer which is built in. The printer issues a receipt on which purchase details are printed. The printer is provided with a cutter that cuts band-shaped paper to form the receipt. The cutter performs a full cut or a partial cut.

The full cut is a cutting method for completely cutting the band-shaped paper across the full width, and severing the receipt from the paper. The partial cut is a cutting method for cutting the paper such that an uncut portion remains in a boundary of the band-shaped paper and the receipt. The partial cut is performed in a case where the issued receipt is prevented from falling off from the POS terminal device. In the case of the partial cut, the operator grasps the receipt and manually tears off the receipt from the uncut portion. There is a problem in which a location of such tearing does not have a neat appearance in comparison to an end that is cut by the cutter.

In addition, in recent years, the receipt that is handed to the customer after settlement includes promotional information, coupons, or the like in addition to the purchase details and is long in comparison to a normal receipt of the related art. Even if the receipt does not include promotional information or coupons, it may still be long in a case where the purchased number of items is large. The long receipt is folded as appropriate by the operator and handed to the customer.

### DESCRIPTION OF THE DRAWINGS

FIG. 1 is a perspective view of a POS terminal device according to a first embodiment.

FIG. 2 is a diagram schematically illustrating a structure of a printer.

FIG. 3A is a schematic diagram illustrating an operation of a temporary fastening section, during a state before movement of a movable clamp.

FIG. 3B is a schematic diagram that illustrating an operation of the temporary fastening section, during a state during movement of the movable clamp.

FIG. 3C is a schematic diagram that illustrating an operation of the temporary fastening section, during a state after movement of the movable clamp.

FIG. 4 is a diagram illustrating the operation of the movable clamp and a movable blade.

FIG. 5 is a diagram illustrating an operation of the movable clamp.

FIG. 6 is a diagram illustrating an operation of the movable blade.

FIGS. 7A and 7B are diagrams illustrating an operation of the movable clamp and the movable blade.

FIG. 8 is a block diagram illustrating an electrical connection of the printer.

FIG. 9 is a block diagram illustrating a functional configuration of the printer.

FIG. 10 is a diagram illustrating a state in which the movable clamp holds a tip end portion of the paper.

FIG. 11 is a diagram illustrating a state in which the paper is discharged from an issue opening in a loop shape.

FIG. 12 is a diagram illustrating an outer appearance example of a receipt that is discharged in the loop shape.

FIG. 13 is a flow chart illustrating a process flow of a second embodiment.

### DETAILED DESCRIPTION

According to embodiments, band-shaped paper is prevented from falling off from a device even when it is fully cut.

In general, according to an embodiment, there is provided a printer apparatus including a printing section along a transport path of a printable medium disposed downstream of the printing section along the transport path of the printable medium, a cutting section, and a temporary fastening section disposed downstream of the cutting section along the transport path of the printable medium. The temporary fastening section is configured to hold a leading edge portion of the printable medium at a position laterally offset from the transport path at a time the printable medium is cut by the cutting section after printing by the printing section.

### First Embodiment

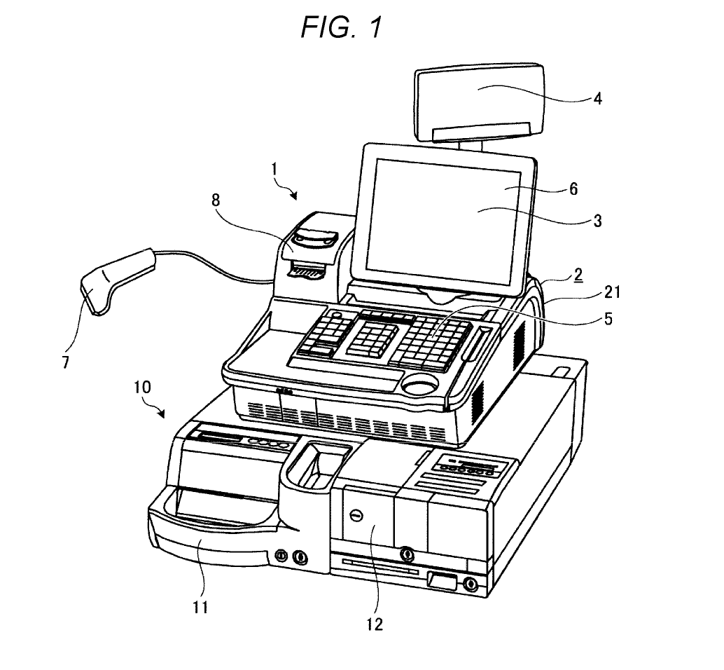

A first embodiment will be described with reference to the drawings. FIG. 1 is a perspective view illustrating an outer appearance of a POS terminal device 1 which is provided with a printer as an example of a printer apparatus according to the first embodiment. The POS terminal device 1 includes a main body 2, a display 3, a sub display 4, a keyboard 5, a touch panel 6, a bar code scanner 7, and a printer 8.

The POS terminal device 1 mounted on a money depositing and dispensing device 10. The money depositing and dispensing device 10 includes a coin depositing and dispensing section 11 and a bill depositing and dispensing device 12. The money depositing and dispensing device 10 performs calculation of a deposit amount and a dispensing amount, and dispenses change according to a signal that is output by the POS terminal device 1.

The main body 2 includes a box type casing 21, and a control section (not illustrated) that collectively controls each section (display 3, sub display 4, keyboard 5, touch panel 6, bar code scanner 7, and printer 8) that is built in.

The display 3 is provided to stand on an upper surface of the main body 2 on the rear side of the main body 2, and displays various information to the operator using characters or an image. The sub display 4 is provided on the rear side of the display 3, and displays various information using characters or an image toward a purchaser of products during sales data processing and during settlement.

The keyboard 5, the touch panel 6, and the bar code scanner 7 are operation sections that receive an input operation from an operator, and are operation sections that send output to the control section according to the input operation of the operator. The keyboard 5 is provided on the upper surface of the main body 2 on the front side of the main body 2, and receives an input operation from the operator. The touch panel 6 is stacked on a front surface of the display 3, and receives an input operation from the operator. The bar code scanner 7 reads a bar code that is affixed to a product.

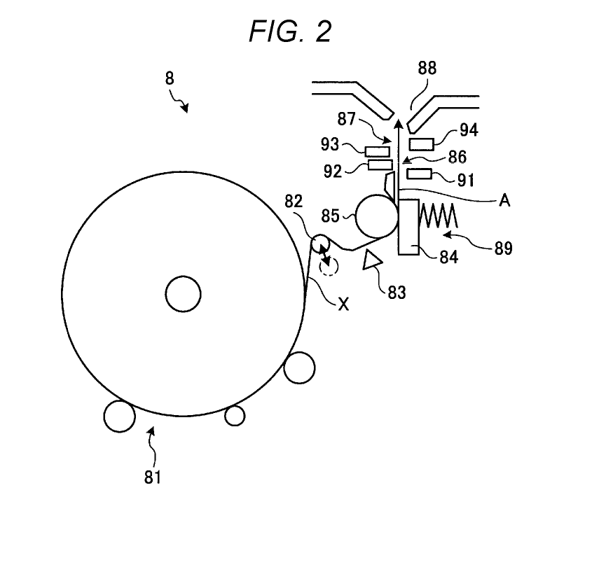

The printer 8 is an example of a printer apparatus. The printer 8 prints and issues a receipt. The receipt is a slip of paper that displays purchase details, that is, a list of products that are the target of settlement, an amount of money, and the like. FIG. 2 is a diagram schematically illustrating a structure of the printer 8.

The printer 8 includes a paper roll holding section 81, a damper 82, a sensor 83, a thermal head 84, a platen roller 85, a cutting section 86, a temporary fastening section 87, and an issue opening 88. The thermal head 84 and the platen roller 85 form a printing section 89. In addition, the platen roller 85 functions as a transport section that transports paper X along a paper transport path A. Here, the paper X is indicated by an arrow in FIG. 2 with an orientation close to the issue opening 88 as a forward transport direction. Hereinafter, “upstream side” and “downstream side” are expressed based on the forward transport direction. Note that, the paper X is an example of a printing medium.

The paper roll holding section 81 holds a paper roll on which the band-shape thermal paper (hereinafter, simply referred to as paper) X is wound to be able to be pulled out. The band-shaped paper X is cut by the cutting section 86.

The damper 82 adjusts the tension of the paper X pulled out from the paper roll holding section 81 to the printing section 89. Thereby, the damper 82 smoothens transport of the paper X in the printing section 89, the feeding speed is held substantially fixed, and contributes to a suitable print quality by reducing variation of transport resistance. The sensor 83 is provided on the upstream side of the printing section 89 and detects the paper X.

The issue opening 88 is at an edge of the paper transport path A, and forms a discharge port through which the paper X that is transported along the paper transport path A is discharged outside of the casing 21. In other words, the issue opening 88 is an opening that is provided in the casing 21 for issuing the receipt.

The printing section 89 is provided in the paper transport path A. The thermal head 84 includes a plurality of heat generating elements individually lined up in a paper width direction, and performs printing on the paper X using the heat generation of the heat generating elements. The thermal head 84 is pressed against a platen roller 85 by biasing using a spring. The platen roller 85 holds the paper X with the thermal head 84. In addition, the platen roller 85 rotates about an axis due to driving force of a motor (not illustrated) to transport the paper X.

The cutting section 86 is provided in the paper transport path A, and is a cutter that cuts the paper X. The cutting section 86 includes a fixed blade 91 and a movable blade 92. The fixed blade 91 and the movable blade 92 are provided to face each other between the printing section 89 and the issue opening 88 during non-operation of the cutting section 86. In other words, the cutting section 86 forms a portion of the paper transport path A using the fixed blade 91 and the movable blade 92 during non-operation.

The fixed blade 91 is fixably provided (immovably positioned) within the printer 8. The movable blade 92 is provided to be freely separable with respect to the fixed blade 91. In other words, the movable blade 92 is provided to freely move between a position of contact with the fixed blade 91 and a position facing and separated from the fixed blade 91 via the paper transport path A. The cutting section 86 cuts the paper X by moving the movable blade 92 to the position of contact with the fixed blade 91.

The fixed blade 91 and the movable blade 92 include a cutting blade that is longer than the width of the paper X, and cuts (fully cuts) the paper X along the entire width.

The temporary fastening section 87 is provided at a position that is closer to the issue opening 88 than the cutting section 86 and the printing section 89 in the paper transport path A. That is, the temporary fastening section 87 is provided on the downstream side of the cutting section 86 and the printing section 89 and the upstream side of the issue opening 88. The temporary fastening section 87 temporarily holds a tip end portion of the paper X when the paper X extends outside the paper transport path A through the issue opening 88.

The temporary fastening section 87 includes a fixed clamp 93 and a movable clamp 94. The movable clamp 94 is movable with respect to the fixed clamp 93. Through the movement, the fixed clamp 93 and the movable clamp 94 are changed from one to the other of a first state and a second state.

The temporary fastening section 87 is in the first state during non-operation in which the paper X is not held. In the first state, the movable clamp 94 is positioned separated from the fixed clamp 93 in a thickness direction of the paper X, and faces the fixed clamp 93. In other words, during non-operation, the temporary fastening section 87 forms a portion of the paper transport path A using the fixed clamp 93 and the movable clamp 94.

The temporary fastening section 87 is in the second state during operation in which the paper X is held. In the second state, the movable clamp 94 holds a tip end portion of the paper X with the fixed clamp 93. In the second state, the movable clamp 94 is positioned past the paper transport path A.

The movable clamp 94 is provided to be movable between a temporary fastening position in which it presses against the fixed clamp 93 via the paper X and a non-operation position facing the fixed clamp 93. Through the movement, the movable clamp 94 moves the paper transport path A in the thickness direction of the paper X. The temporary fastening section 87 during operation moves the movable clamp 94 to a position in which it presses against the fixed clamp 93, and holds the paper X between both (fixed and movable) clamps 93 and 94.

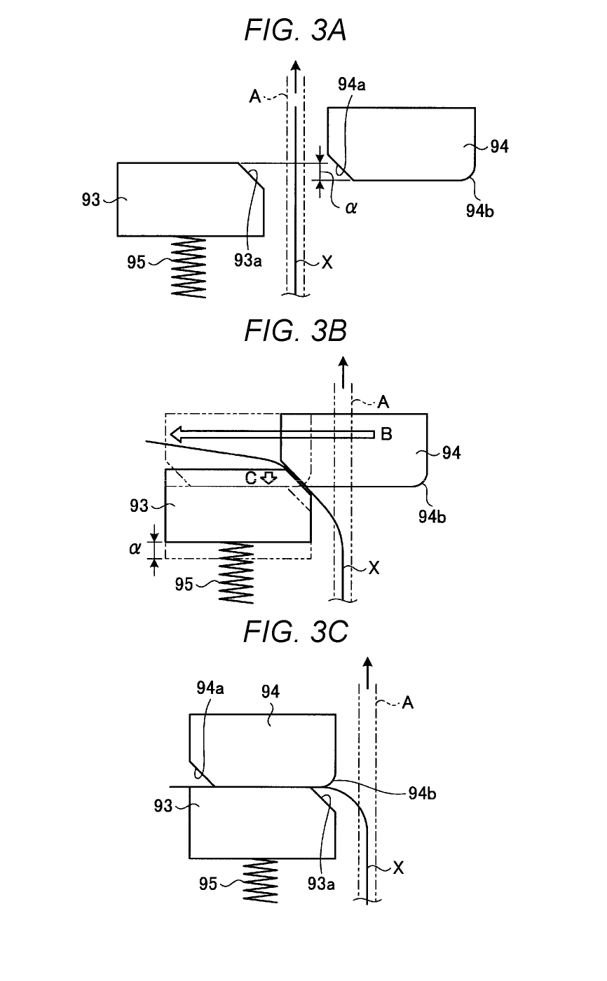

FIGS. 3A, 3B, and 3C are schematic diagrams that describe an operation of the temporary fastening section 87, and are diagrams of the temporary fastening section 87 viewed from the same direction as in FIG. 2. A depth direction toward the drawings is the width direction of the paper X, and a left and right direction in the drawings is the thickness direction of the paper X. The movable clamp 94 moves in the thickness direction of the paper X. FIG. 3A illustrates a state (first state) before movement of the movable clamp 94. FIG. 3B illustrates a state during movement of the movable clamp 94. FIG. 3C illustrates a state (second state) after movement of the movable clamp 94.

The fixed clamp 93 is biased in a direction that is substantially orthogonal to a movement direction of the movable clamp 94.

A spring 95 is an example of an elastic member that performs biasing of the fixed clamp 93. The position of the fixed clamp 93 during non-operation of the temporary fastening section 87 extends to a position that partially overlaps with a position of the movable clamp 94 in the in the paper transport direction. The amount of extension is a which is illustrated in FIG. 3A.

The fixed clamp 93 and the movable clamp 94 are formed with chamfers (e.g., inclined surface 93a and inclined surface 94a) such that the inclined surfaces come into contact during movement of the movable clamp 94. The inclined surface 93a and the inclined surface 94a come into contact with the movement (illustrated by an arrow B in FIG. 3B) of the movable clamp 94, such that the movable clamp 94 rides up the fixed clamp 93, and the fixed clamp 93 is pressed down (illustrated by an arrow C in FIG. 3B). At this time, the movable clamp 94 moves the fixed clamp 93 against the biasing of the spring 95.

When the movable clamp 94 and the fixed clamp 93 are positioned at the temporary fastening position (indicated in FIG. 3C), the movable clamp 94 and the fixed clamp 93 are pressed against each other. Contact pressure corresponds to the amount of displacement of the spring 95 from its free state. The value of the amount of displacement is a which is equal to the amount of extension described above. The temporary fastening section 87 holds the paper X at a force (holding force) according to the contact pressure.

The holding force of the paper X by the temporary fastening section 87 is to a degree such that it is possible to pull the paper X out by hand. The “degree such that it is possible to pull out” means a case where the paper X (that is, receipt) after being cut, is pulled out by the operator by hand, such that the receipt between the movable clamp 94 and the fixed clamp 93 is pulled out without being torn. In order to make it harder for the receipt to be torn during pullout, a corner portion 94b of the movable clamp 94 that comes into contact with the paper X when the paper X is pulled out, is rounded.

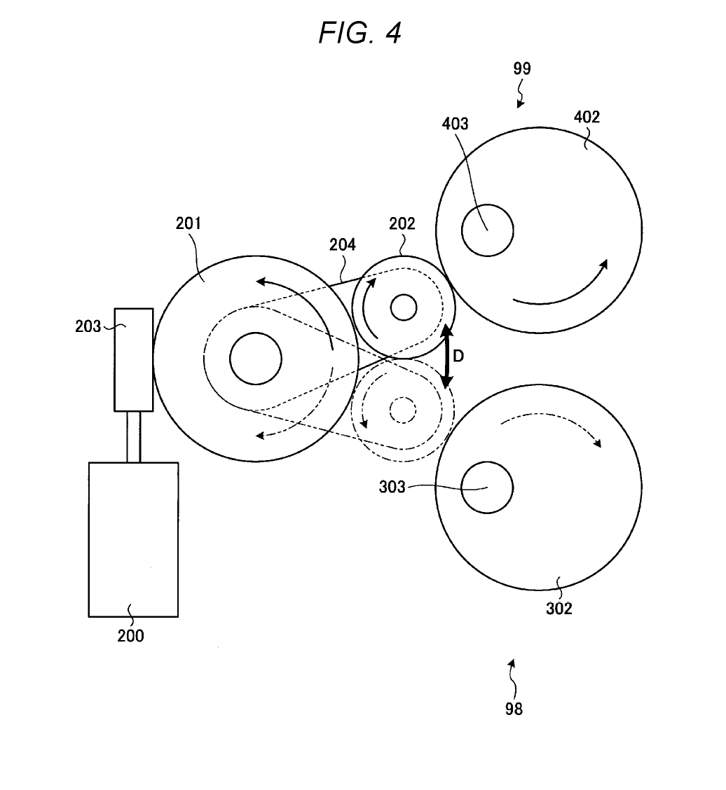

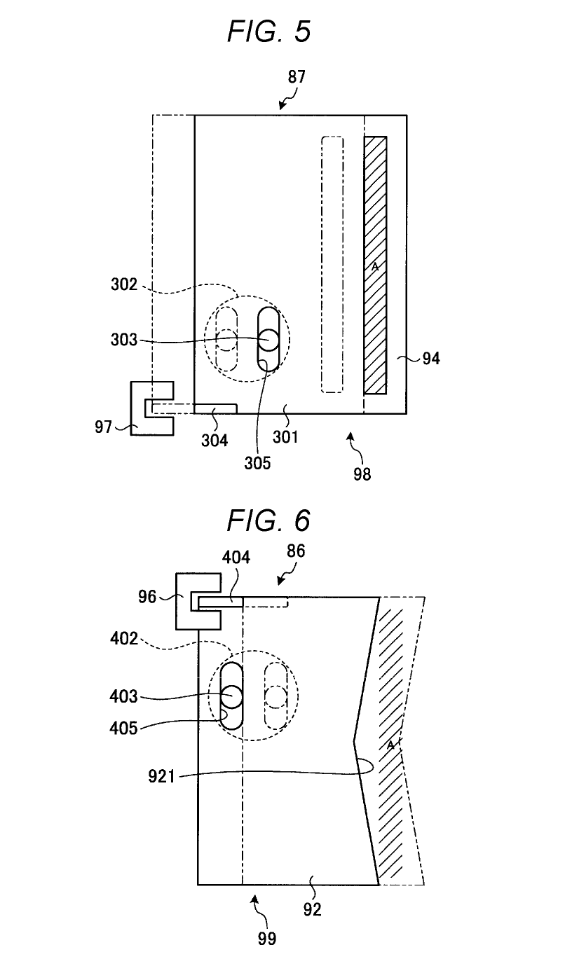

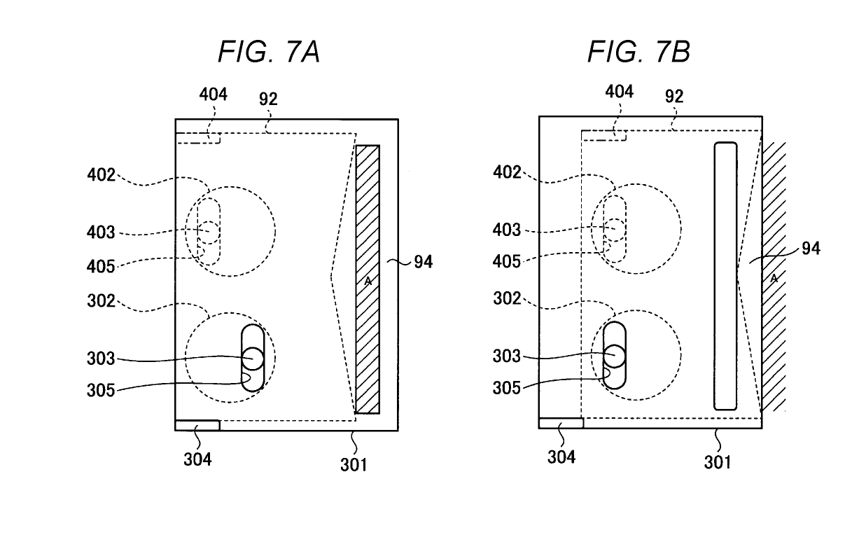

Here, FIG. 4 is a diagram which describes an operation of the movable clamp 94 and the movable blade 92. In addition, FIG. 5 is a diagram which indicates the movable clamp 94 during non-operation (solid line) and during operation (two-dot chain line), and FIG. 6 is a diagram which indicates the movable blade 92 before cutting (solid line) and during cutting (two-dot chain line). Furthermore, FIGS. 7A and 7B are diagrams which indicate the movable clamp 94 (solid line) and the movable blade 92 before cutting (dotted line). FIG. 7A indicates the movable clamp 94 during non-operation, and FIG. 7B indicates the movable clamp 94 during operation.

FIGS. 4 to 7B are diagrams viewed from the same direction. The view direction in FIG. 5, FIG. 6, and FIGS. 7A and 7B is the downstream side of the paper transport path A, such that during forward transport, the paper X is transported from the depth side to the front side in FIG. 5, FIG. 6, and FIGS. 7A and 7B. The left and right directions in FIG. 5, FIG. 6, and FIGS. 7A and 7B are the thickness direction of the paper X.

As shown in FIG. 5, the temporary fastening section 87 further includes a sensor 97, and as shown in FIG. 6, the cutting section 86 further includes a sensor 96. The sensor 96 detects that the movable blade 92 is positioned at a home position during non-operation. The sensor 97 detects that the movable clamp 94 is positioned at the temporary fastening position during operation.

In addition, as shown in FIG. 4, the printer 8 further includes a motor 200. The movable clamp 94 and the movable blade 92 are both moved by transmitting power of the motor 200. The movement direction is orthogonal to the paper transport path A.

As shown in FIG. 5, the temporary fastening section 87 includes a linking section 98 that transmits the power of the motor 200 to the movable clamp 94. The linking section 98 includes a flat plate portion 301, a rotary disc 302, a pin 303, and a portion to be sensed 304 that are integrated with the movable clamp 94. The flat plate portion 301 is formed of a substantially rectangular plate metal, and both end portions of the movable clamp 94 are connected to both corner portions on the long side. Thereby, the long side and the movable clamp 94 interpose the paper transport path A therebetween and face in parallel.

In addition, as shown in FIG. 6, the cutting section 86 includes a linking section 99 that transmits the power of the motor 200 to the movable blade 92. The linking section 99 includes a rotary disc 402, a pin 403, and a portion to be sensed 404. The movable blade 92 includes a cutting blade 921 on one long side of the substantially rectangular plate metal. The cutting blade 921 has a V-shaped valley shape.

As shown in FIG. 4, the printer 8 further includes transmission gears 201 and 202, a pinion 203, and a connection plate 204 to cause the transmission gear 201 to always contact the transmission gear 202. The motor 200 transmits the power to the linking sections 98 and 99 along the transmission gears 201 and 202 and the pinion 203.

The pinion 203 is connected to a revolving shaft of the motor 200. The transmission gear 201 meshes with the pinion 203. The transmission gear 201 and the transmission gear 202 are connected by the connection plate 204 in a meshing state. In FIG. 4, when the transmission gear 201 rotates in a solid line arrow direction, the transmission gear 202 also rotates in the solid line arrow direction and contacts the link section 99. When the transmission gear 201 rotates in a two-dot chain line arrow direction, the transmission gear 202 also rotates in the two-dot chain line arrow direction and contacts the link section 98.

According to the configuration described above, as shown in FIGS. 7A and 7B, the movable clamp 94, the movable blade 92, and each linking section 98 and 99 that are arranged in an overlapping state when viewed from the downstream side to the upstream side in the forward transport direction, are driven by one motor 200.

The rotary disc 302 of the linking section 98 meshes with the transmission gear 202 and receives the power transmission of the motor 200. The pin 303 stands on the upper surface of the rotary disc 302, and fits in a long hole 305 that is provided in the flat plate portion 301. The pin 303 moves inside the long hole 305 in the longitudinal direction accompanying rotation of the rotary disc 302. In addition, the pin 303 moves the flat plate portion 301 by applying force from within the long hole 305 to the flat plate portion 301. Due to moving the flat plate portion 301, the movable clamp 94 moves and the temporary fastening section 87 performs its function.

The rotary disc 402 of the linking section 99 meshes with the transmission gear 202 and receives the power transmission of the motor 200. A pin 403 stands on the upper surface of the rotary disc 402, and fits in a long hole 405 that is provided in the movable blade 92. The pin 403 moves inside the long hole 405 in the longitudinal direction with the rotation of the rotary disc 402. In addition, the pin 403 moves the movable blade 92 by applying force from within the long hole 405 to the movable blade 92. Due to moving the movable blade 92, the cutting section 86 performs its function.

The portion to be sensed 304 is detected using the sensor 97 when the movable clamp 94 is positioned at the temporary fastening position. If the sensor 97 is a light sensor, the portion to be sensed 304 is an oblique light plate that is inserted between a light emitting section and a light receiving section of the sensor 97. The portion to be sensed 304 is provided on the flat plate portion 301.

A portion to be sensed 404 detects using the sensor 96 when the movable blade 92 is positioned at the home position. If the sensor 96 is a light sensor, the portion to be sensed 404 is an oblique light plate that is inserted between a light emitting section and a light receiving section of the sensor 96. The portion to be sensed 404 is provided on the movable blade 92.

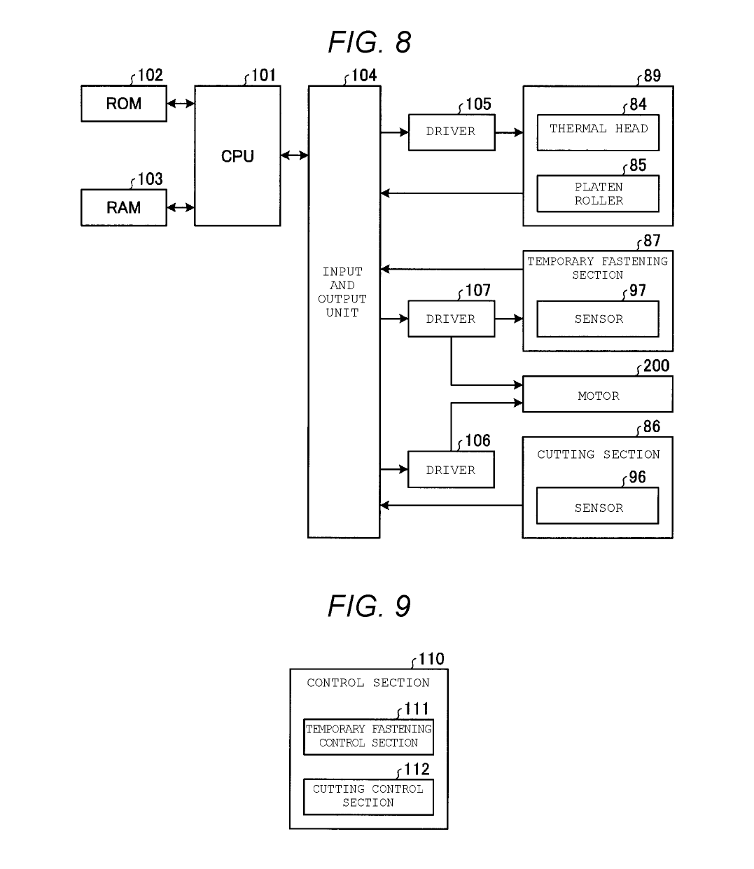

FIG. 8 is a block diagram illustrating an electrical connection of the printer 8. FIG. 9 is a block diagram illustrating a functional configuration of the printer 8. The printer 8 further includes a central processing unit (CPU) 101, a read only memory (ROM) 102, a random access memory (RAM) 103, an input and output unit 104, and drivers 105 to 107.

The ROM 102 stores various programs which are executed by the CPU 101. The RAM 103 is used as a work area that rewritably stores variable data.

The CPU 101 collectively controls each section that forms part of the printer 8 by functioning as various modules by executing various computation processes by executing the program that is stored by the ROM 102 in the RAM 103.

The CPU 101, the ROM 102, and the RAM 103 forma control section 110. The control section 110 includes a temporary fastening control section 111 and a cutting control section 112.

The control section 110 collectively controls each section that configures the printer 8. The temporary fastening control section 111 performs control of a state in which the temporary fastening section 87 is in either state of the first state or the second state. The temporary fastening control section 111 transmits a control signal to a driver 107 in order to move the movable clamp 94. The cutting control section 112 transmits the control signal to a driver 106 in order to move the movable blade 92. The drivers 106 and 107 drive the motor 200 when receiving the control signal.

The input and output unit 104 relays exchange of the signal of the CPU 101, the drivers 105 to 107, the printing section 89, the temporary fastening section 87, and the cutting section 86.

The driver 105 transmits the control signal to the printing section 89 based on control of the control section 110. The printing section 89 operates based on the control signal that is received from the driver 105, and returns a feedback signal to the control section 110 via the input and output unit 104. The driver 106 transmits the control signal to the temporary fastening section 87 based on control of the control section 110. The temporary fastening section 87 operates based on the control signal that is received from the driver 106, and returns a feedback signal to the control section 110 via the input and output unit 104. The driver 107 transmits the control signal to the cutting section 86 based on control of the control section 110. The cutting section 86 operates based on the control signal that is received from the driver 107, and returns a feedback signal to the control section 110 via the input and output unit 104.

The operation of the printer 8 configured in this manner will be described below. The printer 8 operates when the control section 110 receives data (printing data) that is to be printed from the control section (not illustrated) of the POS terminal device 1. That is, the control section 110 transmits an instruction to the driver 105, and the printing section 89 that receives the instruction via the driver 105 starts printing based on the printing data.

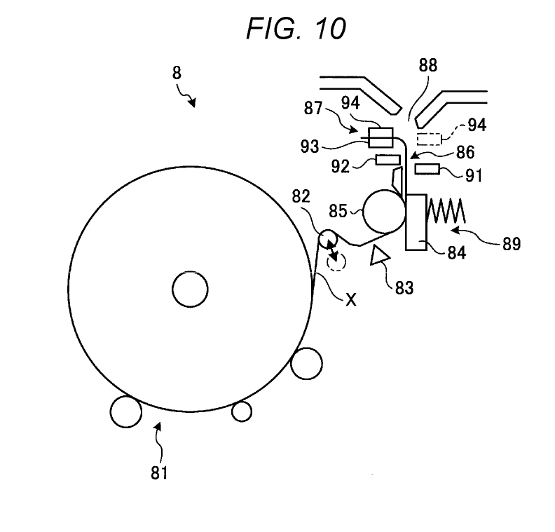

When the tip end portion of the paper X that is positioned at the cutting section 86 at the time when the printing starts reaches the temporary fastening section 87 as the printing proceeding, the temporary fastening control section 111 moves the movable clamp 94. FIG. 10 is a diagram illustrating a state (second state) in which the movable clamp 94 holds a tip end portion of the paper X. In comparison, the temporary fastening section 87 in the first state is illustrated in FIG. 2.

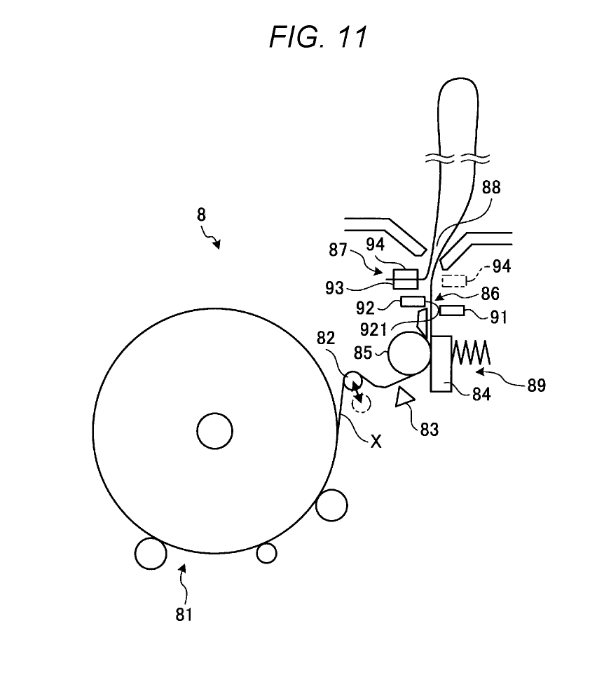

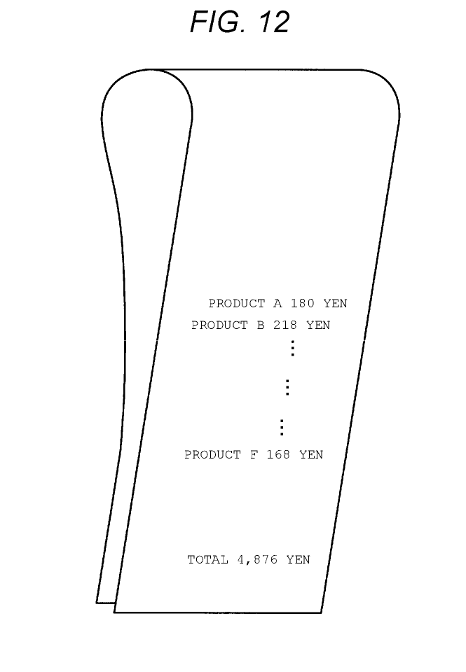

When the printing section 89 further proceeds with printing, the paper X is transported as the printing proceeds, in the arrow A direction while held by the tip end portion, and is discharged in a loop shape through the issue opening 88. FIG. 11 is a diagram illustrating a state in which the paper X is discharged from the issue opening 88 in a loop shape. In addition, FIG. 12 is a diagram illustrating an outer appearance example of the receipt that is discharged in the loop shape.

When the printing section 89 completes printing, the cutting control section 112 moves the movable blade 92 by rotating the transmission gear 201 in the solid line arrow direction in FIG. 4. Due to movement of the movable blade 92, when a cutting blade 921 cuts across the paper transport path A, the paper X is cut and becomes a receipt. At this time, a rear end portion of the receipt is in a free state, but as indicated by the two-dot chain line in FIG. 5, the tip end portion is held in the temporary fastening section 87. Note that, as described above, the receipt that is held by the temporary fastening section 87 is able to be pulled out manually.

In this manner, according to the present embodiment, it is possible to hold and discharge the receipt that is able to be pulled out manually. Thereby, also in full cutting, it is possible to prevent falling off of the receipt. In addition, since receipt issuing is possible by full cutting, it is possible to provide a receipt with a neat cut end.

In addition, according to the present embodiment, it is possible to discharge the receipt in a loop shape. Thereby, handling of a long receipt is easy. In more detail, it is possible to lower labor to adequately fold the long sheet when handing to the customer.

Furthermore, the temporary fastening section 87 according to the present embodiment holds the tip end portion of the paper X such that the printing surface of the receipt is folded outward as illustrated in FIG. 12. Consequently, since the printing surface of the receipt is discharged in the loop shape toward the outer side, it is possible to easily confirm the amount of money of a total amount and the like.

### Second Embodiment

A second embodiment will be described with reference to the drawings. The present embodiment is a modified example of the first embodiment. In the present embodiment, description of the same portions as in the first embodiment is omitted, and portions that are different from the first embodiment are described. In addition, in the present embodiment, the same portions as in the first embodiment use the same reference numerals.

In the first embodiment, the temporary fastening section 87 holds the tip end portion of the paper regardless of the amount of printing content, but in the present embodiment, the temporary fastening control section 111 changes control according to the printing content.

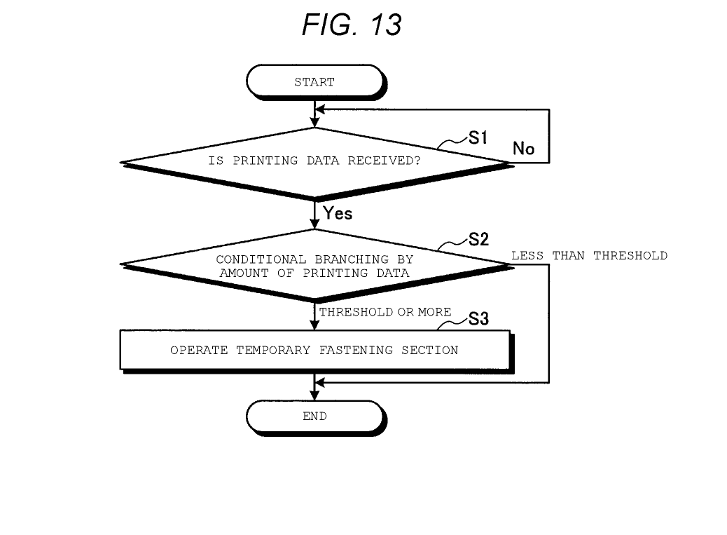

FIG. 13 is a flow chart schematically illustrating a process flow that is performed by the temporary fastening control section 111. The temporary fastening control section 111 awaits reception of data (printing data) that is to be printed from the control section (not illustrated) of the POS terminal device 1 by the control section 110 of the printer 8 (step S1: No).

When the control section 110 receives printing data (step S1: Yes), the temporary fastening control section 111 performs conditional branching of the process according to the amount of printing data (step S2). That is, if the amount of printing data is a predetermined threshold or more (step S2: threshold or more), the temporary fastening control section 111 operates the temporary fastening section 87 (step S3). That is, in a case where the receipt is long, the temporary fastening control section 111 discharges the receipt in a loop shape by holding the tip end portion of the paper.

In addition, in step S2, if the amount of printing data is less than the predetermined threshold (step S2: less than threshold), the temporary fastening control section 111 ends the process without performing step S3. That is, in a case where the receipt is short (where the printing content is slight), the temporary fastening control section 111 does not hold the paper X using the temporary fastening section 87 by retaining the temporary fastening section 87 in the first state without operating the temporary fastening section 87.

In this manner, the temporary fastening control section 111 may perform control according to the printing content. For example, as described above, the temporary fastening section 87 may not hold the paper X during non-operation under a condition in which the amount of printing data is slight with reference to a predetermined value (threshold described above in the present embodiment). Alternatively, in a case where the amount of the printing data is big in comparison to the reference, printing may be performed by setting the temporary fastening section 87 in the second state.

Note that, in the embodiment described above, the temporary fastening section 87 has a structure to hold by interposing the tip end portion of the paper in the thickness direction using the fixed clamp 93 and the movable clamp 94, but the embodiment is not limited to the structure. That is, as far as the temporary fastening section is able to hold the paper, the structure does not matter.

In addition, the temporary fastening section 87 of the embodiment described above includes the spring 95 as an elastic member that performs biasing of the fixed clamp 93, but the embodiment is not limited to the configuration. The embodiment may be achieved as long as the fixed clamp 93 and the movable clamp 94 press fit with predetermined elastic force. Accordingly, the biasing may be performed by the movable clamp 94 and not the fixed clamp 93. In addition, the member that performs the biasing may not be a helical spring, and the locations at which the biasing member is provided may be different.

Then, in the embodiment described above, the printer 8 that includes the POS terminal device 1 is described as an example of the printer apparatus, but in the embodiment, the printer apparatus may not be the printer 8 that is provided with the POS terminal device 1, and may be a printer apparatus that cuts and discharges the band-shaped paper.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer apparatus comprising:
a printing section along a transport path of a printable medium;
a cutting section disposed downstream of the printing section along the transport path of the printable medium; and
a temporary fastening section disposed downstream of the cutting section along the transport path of the printable medium, and configured to hold a leading edge portion of the printable medium at a position laterally offset from the transport path at a time the printable medium is cut by the cutting section after printing by the printing section.

2. The printer apparatus according to claim 1,
wherein the temporary fastening section is configured to hold the leading edge portion of the printable medium as the printable medium is advanced during printing, such that a printing surface of the printable medium is folded.

3. The printer apparatus according to claim 2,
wherein the temporary fastening section includes an elastic member against which the printable medium is pressed and held.

4. The printer apparatus according to claim 3,
wherein the temporary fastening section is movable between a first position at which the printable medium is held thereby and a second position at which the printable medium is not held thereby.

5. The printer apparatus according to claim 4, further comprising:
a control section configured to control the temporary fastening section to be in either the first position or the second position.

6. The printer apparatus according to claim 5,
wherein the control section sets the temporary fastening section to be in the second position when the amount of printing data is determined to be larger than a threshold amount.

7. The printer apparatus according to claim 1, wherein the printing section includes a thermal head and a roller between which the printable medium is held during the printing.

8. The printer apparatus according to claim 7, wherein the roller is driven to rotate and advance the printable medium during the printing.

9. The printer apparatus according to claim 8, further comprising:
a discharge port through which the printable medium is discharged,
wherein the printable medium is discharged through the discharge port in a loop shape as the leading edge of the printable medium is held by the temporary fastening section when a printing amount is greater than a threshold amount.

10. The printer apparatus according to claim 9,
wherein the leading edge of the printable medium is discharged through the discharge port when the printing amount is less than the threshold amount.

11. A method of printing on a printable medium, comprising:
conveying the printable medium along a transport path to a printing section;
printing on the printable medium as the printable medium is conveyed;
conveying the printable medium past a cutting section that is downstream of the printing section to a temporary fastening section;
clamping a leading edge portion of the printable medium at the temporary fastening section at a position laterally offset from the transport path; and
while the leading edge portion of the printable medium is clamped at the temporary fastening section, cutting the printable medium.

12. The method according to claim 11,
clamping the leading edge portion of the printable medium as the printable medium is advanced during the printing, such that a printing surface of the printable medium is folded.

13. The method according to claim 12,
wherein the clamping includes pressing the printable medium against an elastic member.

14. The method according to claim 11, wherein the printing section includes a thermal head and a roller between which the printable medium is held during the printing.

15. The method according to claim 11, wherein the roller is driven to rotate and advance the printable medium during the printing.

16. The method according to claim 15, further comprising:
a discharge port through which the printable medium is discharged,
wherein the printable medium is discharged through the discharge port in a loop shape as the leading edge of the printable medium is held by the temporary fastening section.

17. A method of printing on a printable medium, comprising:
conveying the printable medium along a transport path to a printing section;
printing on the printable medium as the printable medium is conveyed;
conveying the printable medium past a cutting section that is downstream of the printing section to a temporary fastening section configured to clamp a leading edge portion of the printable medium at a position laterally offset from the transport path;
determining whether or not the leading edge portion of the printable medium should be clamped at the temporary fastening section; and
cutting the printable medium, wherein the cutting is performed while the leading edge portion of the printable medium is clamped at the temporary fastening section when a printing amount is greater than a threshold amount and the cutting is performed without clamping the leading edge portion of the printable medium at the temporary fastening section when the printing amount is less than the threshold amount.

18. The method according to claim 17,
wherein the printable medium is discharged through a discharge port in a loop shape prior to the cutting.

19. The method according to claim 17,
wherein the leading edge of the printable medium is discharged through the discharge port.
